(19) United States
(12) Patent Application Publication
(10) Pub. No.: US 2018/0258732 A1
(43) Pub. Date: Sep. 13, 2018

(54) DOWNHOLE OILFIELD DEVICE WITH SHEARABLE AND REMOVABLE COMPOSITE FASTENERS

(71) Applicant: GENERAL PLASTICS & COMPOSITES, L.P., Houston, TX (US)

(72) Inventor: Jarrad ZAISER, Houston, TX (US)

(73) Assignee: GENERAL PLASTICS & COMPOSITES, L.P., Houston, TX (US)

(21) Appl. No.: 15/914,629

(22) Filed: Mar. 7, 2018

Related U.S. Application Data
(60) Provisional application No. 62/469,979, filed on Mar. 10, 2017.

(51) Int. Cl. E21B 33/12; E21B 29/00; F16B 33/00

(52) U.S. Cl. CPC E21B 33/1204; F16B 33/006; E21B 29/00

(57) ABSTRACT

The present disclosure provides a device and method for a composite fastener that can withstand the required shear stresses during operation of a downhole oil field device similar to a metal fastener until activated and yet be easily removable after shear or other intended failure. The composite fastener can act as a replacement for a typical metal fastener due to the enhanced strength of the composite fastener.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

### Field of the Invention

The disclosure generally relates to system and method for oil field equipment with shearable composite fasteners. More specifically, the disclosure relates to a system and method for downhole oil field devices, including downhole plugs, with shearable and removable composite fasteners.

### Description of the Related Art

Downhole oil field devices in a wellbore are often operated remotely from the surface by tooling actuation sequences that cause mechanical components to move in a prescribed manner. A frequent method of actuation is increased pressure on portions of the device to selectively shear fasteners to set the device in a well bore. Fracturing plugs, bridge plugs, and other downhole devices can use shear pins, screws, and other types of fasteners to temporarily couple components together until the tooling actuation sequence separates the components. Often after the device is set in place in the wellbore and its purpose completed, the device is then drilled out of the wellbore for the next phase of operations. Historically, soft metal, such as cast iron, has been used as the structural material to support seals and other elastomeric components in the device to promote ease of drilling out the device in the wellbore. In recent years, composite plugs and other types of downhole oilfield devices have gained acceptance in the industry and can facilitate drilling out the device at a faster rate than a metal device. However, to date, the industry has continued to use metal fasteners in the composite devices due to the strength, temperature, and other needs of the application. If a composite fastener could be used in place of the metal fasteners, drilling out the device from the wellbore or in another application could be simplified or expedited.

In other applications, the downhole device is retrieved after the operation for reuse and is not destroyed by drilling out of the wellbore. However, any metal fasteners that may have been sheared or otherwise activated to uncouple components will likely need replacement. The metal fasteners are often deformed from the shearing and wedged in place. The remaining portions of the metal fasteners can be drilled out, any required hole or walls repairs made, and new fasteners can be inserted for the next use.

Therefore, there remains a need for an improved system and method that can efficiently and quickly remove the fasteners in downhole device.

### BRIEF SUMMARY OF THE INVENTION

The present disclosure provides a device and method for a composite fastener that can withstand the required shear stresses during the operation of a downhole oil field device similar to a metal fastener until activated and yet be easily removable after shear or other intended failure. The composite fastener can act as a replacement for a typical metal fastener due to the enhanced strength of the composite fastener.

The present disclosure provides a downhole oilfield device comprising: a first downhole component; a second downhole component; and a composite screw coupling the first downhole component with the second downhole component and having a plurality of fibers within a resin matrix.

The present disclosure provides a method of using a composite screw in a downhole device having a first downhole component, a second downhole component; and a composite screw having a plurality of fibers within a resin matrix, the method comprising: coupling the first downhole component with the second downhole component with the composite screw; activating the downhole device; shearing the composite screw; retrieving a first downhole component with a remaining portion of the composite screw in the first downhole component; and removing the remaining portion of the composite screw.

### BRIEF DESCRIPTION OF THE SEVERAL VIEWS OF THE DRAWINGS

FIG. 1 is a schematic cross sectional view of an illustrative downhole device with one or more composite fasteners.

FIG. 2A is a schematic perspective view of an illustrative composite fastener.

FIG. 2B is a schematic side view of the composite fastener of FIG. 2A.

FIG. 2C is a schematic cross sectional view of the composite fastener of FIG. 2B.

FIG. 2D is a schematic cross sectional view of another composite fastener of FIG. 2B.

FIG. 2E is a schematic cross sectional view of another composite fastener of FIG. 2B.

FIG. 3A is a schematic perspective view of another illustrative composite fastener.

FIG. 3B is a schematic side view of the composite fastener of FIG. 3A.

FIG. 3C is a schematic cross sectional view of the composite fastener of FIG. 3B.

FIG. 4A is a schematic perspective view of another illustrative composite fastener.

FIG. 4B is a schematic side view of the composite fastener of FIG. 4A.

FIG. 4C is a schematic cross sectional view of the composite fastener of FIG. 4B.

### DETAILED DESCRIPTION

The Figures described above and the written description of specific structures and functions below are not presented to limit the scope of what Applicant has invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present disclosure will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation or location, or with time. While a developer's efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. The use of a singular term, such as, but not limited to, “a,” is not intended as limiting of the number of items. Further, the various methods and embodiments of the system can be included in combination with each other to produce variations of the disclosed methods and embodiments. Discussion of singular elements can include plural elements and vice-versa. References to at least one item may include one or more items. Also, various aspects of the embodiments could be used in conjunction with each other to accomplish the understood goals of the disclosure. Unless the context requires otherwise, the term “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. The order of steps can occur in a variety of sequences unless otherwise specifically limited. The various steps described herein can be combined with other steps, interlineated with the stated steps, and/or split into multiple steps. Some elements are nominated by a device name for simplicity and would be understood to include a system or a section, such as a processor would encompass a processing system of related components that are known to those with ordinary skill in the art and may not be specifically described.

The present disclosure provides a device and method for a composite fastener that can withstand the required shear stresses during operation of a downhole oil field device similar to a metal fastener until activated and yet be easily removable after shear or other intended failure. The composite fastener can act as a replacement for a typical metal fastener due to the enhanced strength of the composite fastener.

Traditional teaching and understandings would lead one with ordinary skill in the art away from such a composite fastener. Traditional molded fasteners have such poor shear strength as to be impractical for this application. Thus, the industry has focused on metal fasteners. The present invention provides a composite structure that is of such shear strength that the goal of using a composite fastener is practically achievable. Further, in at least some embodiments, the composite fastener readily breaks in shear at the intended time and allows simple removal, such as by a screwdriver, wrench, or similar hand tool rotating the remaining portion of the fastener out of a threaded hole for an easy replacement.

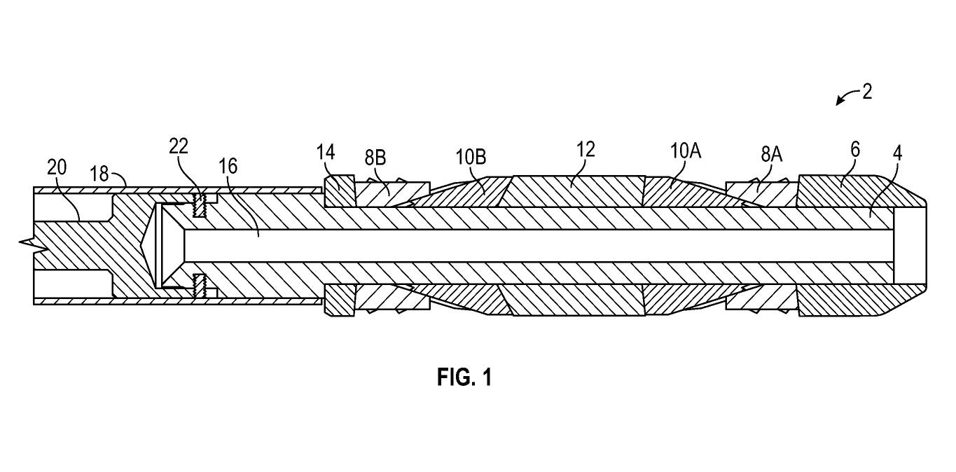

FIG. 1 is a schematic cross sectional view of an illustrative down hole device with one or more composite fasteners. The downhole device 2, such as a fracturing plug, includes various components that are coupled together with some being coupled by one or more composite fasteners. A mandrel 4 having a flow channel 16 therethrough is coupled with various other components, including: a bottom shoe 6 on downhole end of the mandrel, a first slip 8A, a first wedge 10A, an elastomeric seal 12, a second wedge 10B, a second slip 8B, and a spacer ring 14. The mandrel 4 is slidably coupled with a bottom hole assembly 18. A setting tool 20 is releasably coupled to the mandrel with a plurality of composite fasteners 22.

In actuation, the downhole oilfield device 2 is positioned in a wellbore at a desired location. The bottom hole assembly 18 is pushed downhole while the setting tool 20 holds the mandrel 4 with the attached components in position in the wellbore. As the bottom hole assembly 18 pushes on the spacer ring 14, components on the mandrel are compressed longitudinally and move radially outward. The slips 8A and 8B expand outward to grip an internal wall of the wellbore (not shown) and the seal 12 expands outwardly to seal against the internal wall of the wellbore. With sufficient force exerted by the bottom hole assembly, the shearing pressure on the composite fasteners 22 cause the screws to shear and release the mandrel 4 from the setting tool. 20. The bottom hole assembly 18 and mandrel 4 can be pulled up the wellbore, leaving the device 2 in an activated position in the wellbore. After the device has fulfilled its purpose in the wellbore, the device with the sheared portions of the composite fasteners 22 in the mandrel can be readily drilled out to progress to a next stage of operations.

At the surface after retrieval, the setting tool 20 can be processed for reuse. Due to the composite structure of the composite fasteners 22, the fasteners can be readily removed from the setting tool 20. In most cases, the composite fasteners 22 can be unscrewed from the mandrel, if formed as a screw, or readily punched out, if formed as an unthreaded fastener. Advantageously, the composite fasteners 22 can be formed to shear and yet still be removable from the setting tool with hand tools not requiring extensive force or effort. It is understood that the above example of a downhole oilfield device is merely illustrative. The principles can apply to a variety of devices and configurations.

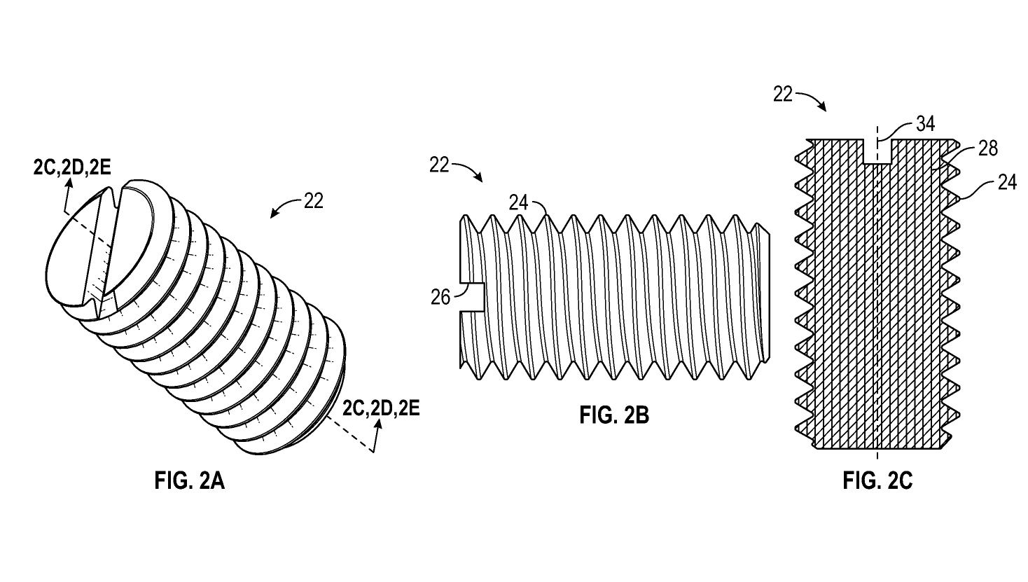

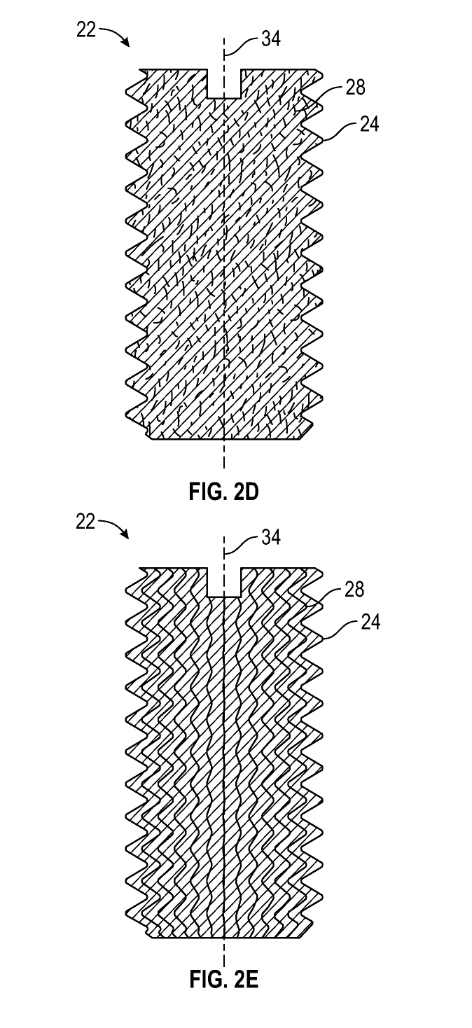

FIG. 2A is a schematic perspective view of an illustrative composite fastener. FIG. 2B is a schematic side view of the composite fastener of FIG. 2A. FIG. 2C is a schematic cross sectional view of the composite fastener of FIG. 2B. In this embodiment, the composite fastener 22 can be formed as an all-thread screw with threads 24. An engagement element 26 can be formed on one end of the fastener, such as a slot, or other portion formed to allow torque to be exerted on the fastener for turning the fastener in a mating thread. The cross-section in FIG. 2C of the fastener 22 shows a composition of structural fibers 28. The structural fibers can be any structural fiber, including microfibers and nanofibers, of various materials, and advantageously non-metallic materials, such as glass, carbon, ceramic, and other structural materials. In at least one embodiment, an advantageous fiber material is of a basalt composition. The basalt composition provides advantageous strength and shearing capabilities to more closely approach the shearing strength of a typical metal fastener, and helps retain the fastener shape from undue deformation within the threaded hole of the mandrel or other components. The fibers 28 can be linearly aligned along a longitudinal axis 34 of the composite fastener 22. Alternatively, the fibers can be aligned off-axis, that is, in a nonparallel direction to the longitudinal axis. Still further alternatively, the fibers can be aligned longitudinally and off-axis, such as a portion of the fibers aligned longitudinally and a portion of the fibers aligned off axis. The fibers can at least in part provide unidirectional shear strength transverse to the longitudinal axis 34. Thus, remaining portions of the composite fastener can be more easily removed after shearing, such as by common hand tools operated by hand (drills, screwdriver, punch and hammer, and the like), known to those with ordinary skill in the art.

FIG. 2D is a schematic cross sectional view of another composite fastener of FIG. 2B. In this embodiment, the composite faster 22 can be molded, complete with the illustrative threads. Thus, the threads do not need to be machined or cut in FIG. 2D, as is expected for the embodiment shown in FIG. 2C, and may result in strengthened threads by retaining the thread matrix even in the threads. The fibers 28 can be short fibers randomly mixed in the composite that form an internal matrix of fibers in contrast to the prior longitudinal fiber pattern such as shown in FIG. 2C.

FIG. 2E is a schematic cross sectional view of another composite fastener of FIG. 2B. FIG. 2E can be considered a combination of the FIG. 2C and FIG. 2D. FIG. 2E discloses a molded composite part having fibers aligned generally longitudinally as in FIG. 2C, but also formed along or within the thread area to strengthen the threads. Thus, similar to FIG. 2D, the threads may not need to be machined or cut, unlike the expected need in FIG. 2C.

An example of an advantageous material for molding the composite fastener is a brittle resin, such as a phenolic. The brittle resin can shear cleanly without elastic deformation in the direction of the shear (that is, generally laterally to the longitudinal axis in the embodiments shown when threaded into a hole) that would significantly inhibit removal of the fastener after the shear. The brittle resin advantageous is strong as well. As one example, a suitable phenolic is modified phenolic Novalac by Sumitomo, among others.

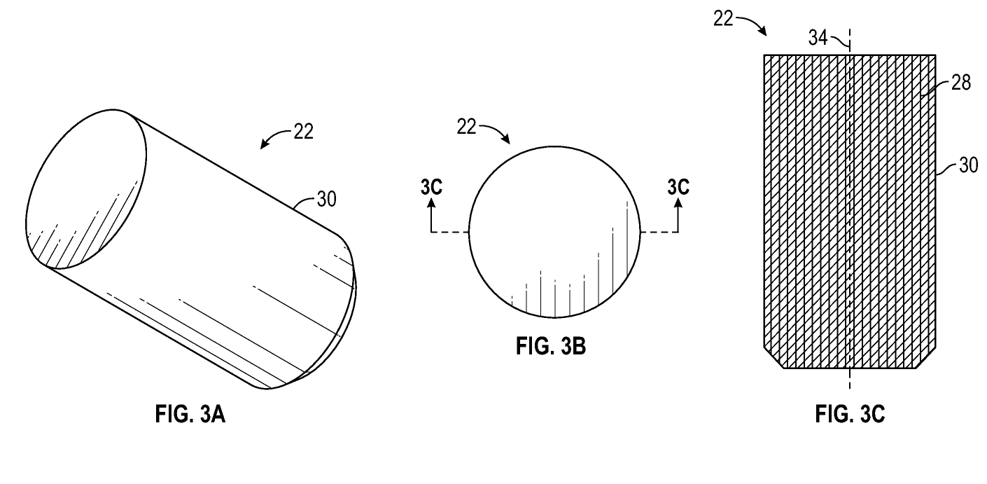

FIG. 3A is a schematic perspective view of another illustrative composite fastener. FIG. 3B is a schematic side view of the composite fastener of FIG. 3A. FIG. 3C is a schematic cross sectional view of the composite fastener of FIG. 3B. In this embodiment, the composite fastener 22 can be smooth and not formed with threads along the side 30. Thus, the composite fastener 22 could act as a pin, such as a shearing pin. In a similar manner as described in FIG. 2C, the fastener 22 can be formed with at least a portion of the fibers 28 aligned in a generally parallel direction of the longitudinal axis 34 for cross-sectional shearing strength, although at least a portion of the fibers could be aligned off-axis. This embodiment can similarly be molded as is described and shown with the underlying considerations of FIG. 2D and FIG. 2E.

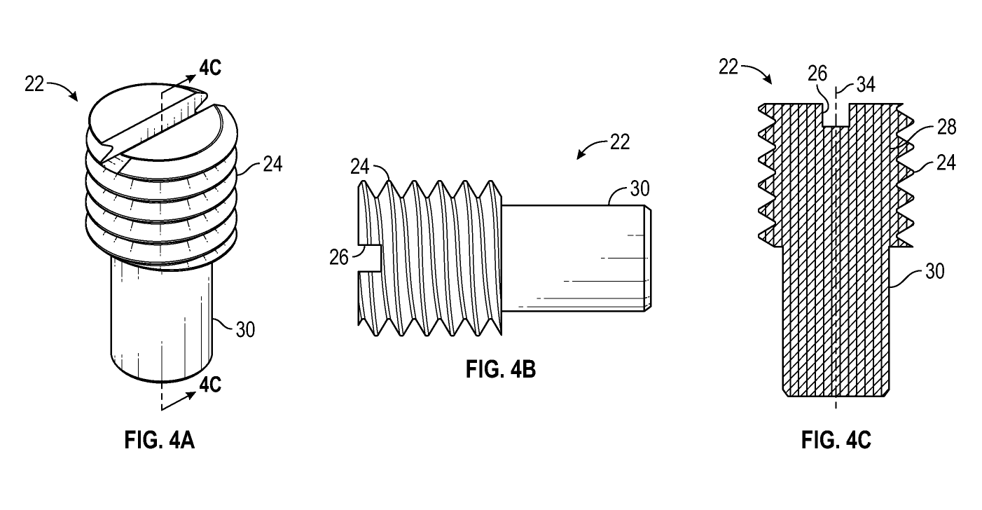

FIG. 4A is a schematic perspective view of another illustrative composite fastener. FIG. 4B is a schematic side view of the composite fastener of FIG. 4A. FIG. 4C is a schematic cross sectional view of the composite fastener of FIG. 4B. In this embodiment, a portion of the composite fastener 22 is formed with threads 24 and a portion of the side 30 is formed without the threads. The threaded portion of the composite fastener 22 can include the engagement element 26, although the other end could include the engagement element or an additional engagement element. At least a portion of the fibers 28 are shown in a longitudinal alignment, as has been described above, although at least a portion of the fibers could be aligned off-axis. This embodiment can similarly be molded as is described and shown with the underlying considerations of FIG. 2D and FIG. 2E.

Other and further embodiments utilizing one or more aspects of the inventions described above can be devised without departing from the disclosed invention as defined in the claims. For example, different fibers having similar characteristics, different weave patterns and orientations, different sizes and shapes, and different downhole devices could be used, along with other variations in keeping within the scope of the claims.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, Applicant intends to protect fully all such modifications and improvements that come within the scope or range of equivalents of the following claims.

What is claimed is:

1. A downhole oilfield device, comprising:
a first downhole component;
a second downhole component; and
a composite screw coupling the first downhole component with the second downhole component and having a plurality of fibers within a resin matrix.

2. The device of claim 1, wherein the coupling is in a shearing configuration when the first downhole component is uncoupled from the second downhole component.

3. The device of claim 1, wherein the fibers comprise basalt fibers.

4. The device of claim 1, wherein the composite screw is formed with threads after being molded.

5. The device of claim 1, wherein the composite screw is formed with threads while molded.

6. The device of claim 1, wherein the fibers are aligned with a longitudinal axis of the composite screw, are aligned at an angle to the longitudinal axis, are loose fibers randomly mixed in the composite screw, or a combination thereof.

7. The device of claim 1, wherein resin for the composite screw comprises a phenolic.

8. A method of using a composite screw in a downhole device having a first downhole component, a second downhole component; and a composite screw having a plurality of fibers within a resin matrix, the method comprising:
coupling the first downhole component with the second downhole component with the composite screw;
activating the downhole device;
shearing the composite screw;
retrieving a first downhole component with a remaining portion of the composite screw in the first downhole component; and
removing the remaining portion of the composite screw.

9. The method of claim 8, wherein the fibers comprise basalt fibers.

10. The method of claim 8, wherein the resin is a phenolic.

11. The method of claim 8, wherein shearing the composite screw results in a sheared cross section that does not elastically deform across the composite screw in a direction of the shear.

12. The method of claim 8, wherein the remaining the remaining portion of the composite screw comprises removing the portion by a hand tool.
